(19) United States
(12) Patent Application Publication
(10) Pub. No.: US 2026/0014898 A1
(43) Pub. Date: Jan. 15, 2026

(54) VCU-LESS VEHICLE EQUIPPED WITH AN MCU AND DISPLAY

(71) Applicant: SPIRO MOBILITY HOLDCO DMCC, Dubai (AE)

(72) Inventors: Rohit PANDITA, Dubai (AE); Himanshu TIWARI, Ghaziabad (IN); Madhup DWIVEDI, New Delhi (IN)

(73) Assignee: SPIRO MOBILITY HOLDCO DMCC, Dubai (AE)

(21) Appl. No.: 19/264,539

(22) Filed: Jul. 9, 2025

(30) Foreign Application Priority Data
Jul. 10, 2024 (IN) 202441052893

(51) Int. Cl. B60L 58/10; H04L 67/12

(52) U.S. Cl. CPC B60L 58/10; H04L 67/12

(57) ABSTRACT

Embodiments herein disclose an electric vehicle (EV), wherein the EV does not include a Vehicle Control Unit (VCU) module, and a Global System for Mobile Communications/General Packet Radio Service (GSM/GPRS) module, and a battery present in the vehicle can communicate data received from a Motor Control Unit (MCU) in the EV to at least one external entity using a GSM/GPRS module, which is present in the battery.

### CROSS REFERENCE TO RELATED APPLICATION

This application is based on and derives the benefit of Indian Provisional Application IN202441052893, the contents of which are incorporated herein by reference.

### TECHNICAL FIELD

Embodiments disclosed herein relate to vehicle control and telemetry systems, and more particularly to using a single telemetry module in an electric vehicle, wherein a battery in the vehicle handles telemetry data, and communication with external modules/entities

### BACKGROUND

In an electric vehicle (EV), a Vehicle Control Unit (VCU) is a control unit (CU) responsible for managing and coordinating various subsystems. The VCU acts as the brain, coordinating, optimizing, and controlling various critical systems in the vehicle to ensure efficient and safe operation.

Typically, the VCU is a standalone device that is connected to the controller and battery from which it communicates using Controller Area Network (CAN) protocols, receives data like State of Charge (SOC), State of Health (SOH), power being drawn, location of vehicle, speed, and so on, and transfers the received data through an onboard stand-alone Global System for Mobile Communications/General Packet Radio Service (GSM/GPRS) module onboard to an external entity (such as, the cloud, a server, and so on).

Thus, in current EVs, there are at least two distinct GSM/GPRS modules assembled into an EV, wherein a first GSM/GPRS module is present in the vehicle and one or more GSM/GPRS modules are present in the batteries present in the EV. In the scenario as depicted in FIG. 1, a Motor Control Unit (MCU) communicates vehicle related data to both the VCU, and at least one battery present in the EV. Both the VCU, and the battery communicate the received data to the external entity (such as, the cloud, a server, and so on). This can result in duplication of functionalities in the EV, and the additional units can result in an increase in costs, and complexity.

Hence, there is a need in the art for solutions which will overcome the above mentioned drawback(s), among others.

### OBJECTS

The principal object of embodiments herein is to disclose an electric vehicle (EV), wherein the EV does not include a Vehicle Control Unit (VCU) module, and a Global System for Mobile Communications/General Packet Radio Service (GSM/GPRS) module, and a battery present in the vehicle can communicate data received from a Motor Control Unit (MCU) in the EV to at least one external entity using a GSM/GPRS module (which is present in the battery).

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a control and telemetry system in an electric vehicle, according to existing arts;

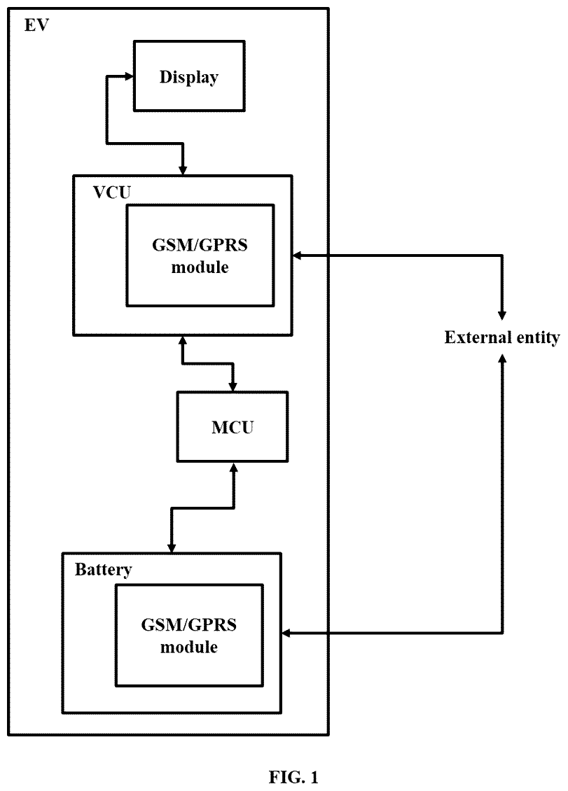

FIG. 2 depicts a telemetry system for an electric vehicle (EV), according to embodiments as disclosed herein;

FIG. 3 is a flowchart depicting the process of managing data communication from an EV, according to embodiments as disclosed herein; and

FIG. 4 is a flowchart depicting the process of managing data communication from an EV, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale.

For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

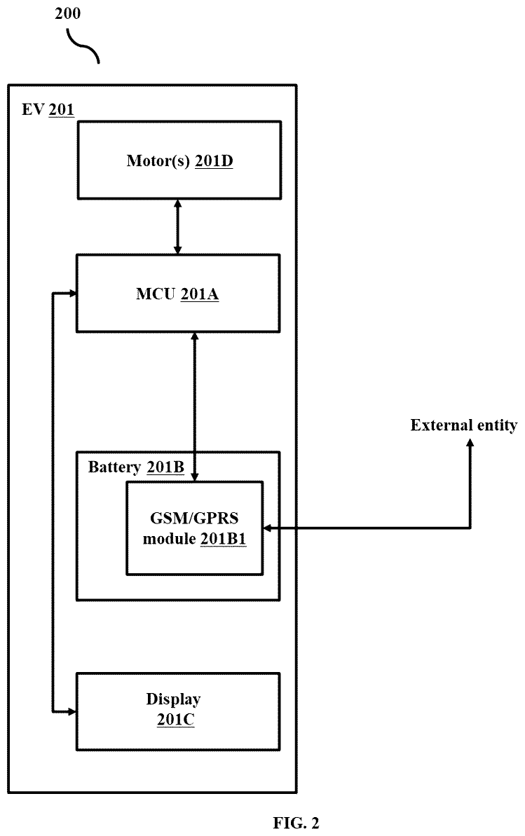

The embodiments herein achieve an electric vehicle (EV), wherein the EV does not include a Vehicle Control Unit (VCU) module, and a Global System for Mobile Communications/General Packet Radio Service (GSM/GPRS) module, and a battery present in the vehicle can communicate data received from a Motor Control Unit (MCU) in the EV to at least one external entity using a GSM/GPRS module (which is present in the battery). Referring now to the drawings, and more particularly to FIGS. 2 through 4, where similar reference characters denote corresponding features consistently throughout the figures, there are shown embodiments.

FIG. 2 depicts a telemetry system for an electric vehicle (EV). The EV as referred to herein can be one of a pure EV, a hybrid vehicle, or any other vehicle that comprises at least one rechargeable battery.

The system 200, as depicted, comprises one or more EVs 201. The EV 201 can further comprise a motor control unit (MCU) 201A, at least one battery 201B, at least one display 201C, at least one motor 201D. The MCU 201A can control and communicate with and control one or more motors 201D present in the vehicle. The one or more motors 201D can control the operation (i.e., movement) of the vehicle, using power provided by the at least one battery 201B.

The EV 201 can also comprise one or more sensors/CUs (not shown). The sensors can monitor one or more parameters related to the EV 201; such as, but not limited to, temperature(s), shocks, vehicle speed, vehicle brakes, vehicle location, status of one or more accessories connected to the EV 201, and so on. The CUs can control one or more modules/systems present in the EV 201; such as, but not limited to, braking systems, regeneration control systems, lighting systems, infotainment systems, accessories present in the EV 101, and so on.

The MCU 201A can be connected to the at least one battery 201B, the at least one display 201C, the one or more motors 201D, and the other modules/sensors/CUs present in the EV 201, using a connection means, which can be at least one of a Controller Area Network, (CAN), a Local Interconnect Network (LIN), FlexRay, SAE J3068 (Electric Vehicle Power Transfer System Using a Three-Phase Capable Coupler), SAE J2716 Single Edge Nibble Transmission (SENT), and so on. The MCU 201A does not include a Global System for Mobile Communications/General Packet Radio Service (GSM/GPRS) module.

The MCU 201A can receive vehicle/motor related data from one or more modules/sensors present in the EV 201 (not shown) and/or the one or more motors 201D. The MCU 201A can communicate the collected vehicle related data to the at least one battery 201B via the communication means. In an embodiment herein, the MCU 201A can communicate the received data to the battery 201B, via the communication means in real time. In an embodiment herein, the MCU 201A can communicate the received data to the battery 201B, via the communication means at periodic intervals. In an embodiment herein, the MCU 201A can communicate the received data to the battery 201B, via the communication means on one or more pre-defined events occurring (such as, but not limited to, an emergency fault with the EV 201, and so on).

The at least one display 201C can be used for displaying information to at least one user of the vehicle. Examples of the display 201C can be, but not limited to, a liquid-crystal display (LCD), light emitting display (LED), thin-film-transistor display (TFT), Active Matrix Organic Light Emitting Diode (AMOLED), one or more dials, one or more lights, and so on. The at least one display 201C can display information received from the MCU 201A, via the connection means. In an embodiment herein, the at least one display 201C can be inbuilt into the vehicle, such as, but not limited to, an instrument console, a vehicle dashboard, a vehicle infotainment system, and so on.

The at least one battery 201B can comprise at least one GSM/GPRS module 201B1. In the embodiment shown herein, the GSM/GPRS module 201B1 is configured to enable communication between the battery 201B, and at least one external entity (such as, but not limited to, a server, the Cloud, and so on) through a network or another cloud. The GSM/GPRS module 201B 1 may be in the form of either a wired network, a wireless network, or a combination thereof. The wired and wireless communication networks may comprise, but are not limited to, Global Positioning System (GPS), Global System for Mobile Communications (GSM), Local Area Network (LAN), Wireless Fidelity (Wi-Fi) compatibility, Bluetooth Low Energy (BLE), Near-field Communication (NFC), and so on. The wireless communication may further comprise one or more of Bluetooth, Zonal Intercommunication Global Standard (ZigBee), short-range wireless communication such as Ultra-wideband (UWB), medium-range wireless communication such as Wi-Fi, or long-range wireless communication such as Third Generation (3G), Fourth Generation (4G), Fifth Generation (5G), Sixth Generation (6G), or Worldwide Interoperability for Microwave Access (WiMAX), according to the usage environment.

The at least one battery 201B can receive the collected data from the MCU 201A, and the display 201C. The battery 201B can communicate the received data to at least one external entity. The battery 201B can communicate the received data to the external entity, via the GPS/GPRS module 201B1. In an embodiment herein, the battery 201B can communicate the received data to the external entity, via the GPS/GPRS module 201B1 in real time. In an embodiment herein, the battery 201B can communicate the received data to the external entity, via the GPS/GPRS module 201B1 at periodic intervals. In an embodiment herein, the battery 201B can communicate the received data to the external entity, via the GPS/GPRS module 201B1 on one or more pre-defined events occurring (such as, but not limited to, an emergency fault with the EV 201, a tampering attempt with the EV, and so on).

Considering an example scenario, wherein the external entity is the Cloud. On receiving the data from the battery 201B (which can comprise of the data from the MCU 201A, data from the display 201C, and/or battery related data), the Cloud can correlate the EV 201 and the battery 201B based on pre-stored information (which was stored at the time of dispensing the battery 201B to the EV 201). Examples of the pre-stored information can be, but not limited to, a battery identification means (ID), manufacturer name, Battery Management System identification means (ID), BMS-related data, and so on.

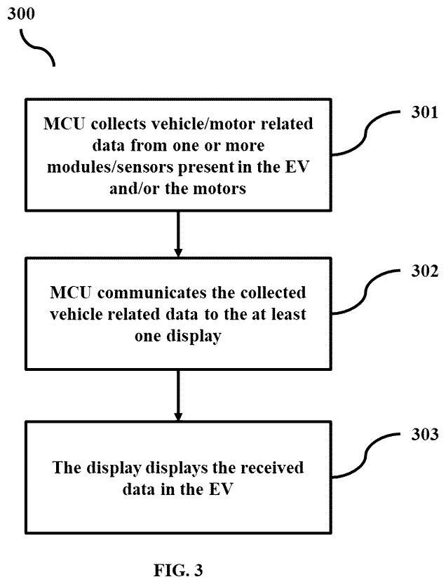

FIG. 3 is a flowchart depicting the process of managing data communication from an EV. In step 301, the MCU 201A collects vehicle/motor related data from one or more modules/sensors present in the EV 201 (not shown) and/or the motors 201D. The MCU 201A communicates the collected vehicle related data to the at least one battery 201B via the communication means in at least one of real time, at periodic intervals, or on one or more pre-defined events occurring (such as, but not limited to, an emergency fault with the EV 201, and so on). In step 302, the MCU 201A communicates the received data to the display 201C. On receiving the data from the MCU 201A, in step 303, the display 201C displays the received data. The various actions in method 300 may be performed in the order presented, in a different order or simultaneously. Further, in some embodiments, some actions listed in FIG. 3 may be omitted.

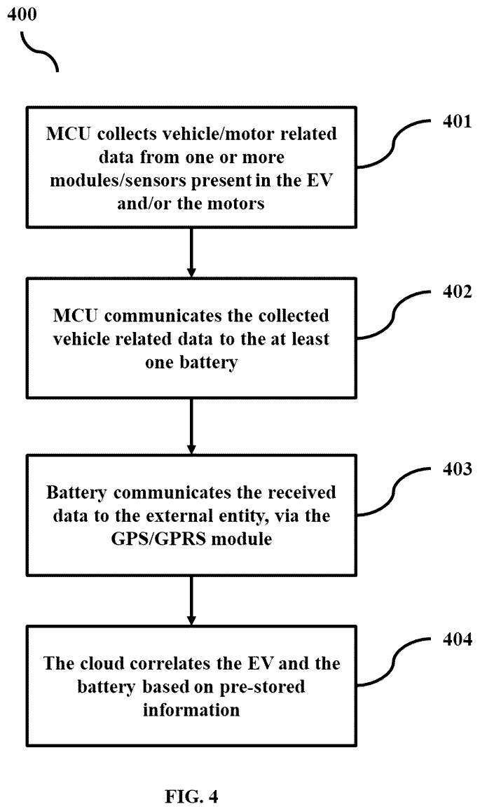

FIG. 4 is a flowchart depicting the process of managing data communication from an EV. In step 401, the MCU 201A collects vehicle/motor related data from one or more modules/sensors present in the EV 201 (not shown) and/or the motors 201D. The MCU 201A communicates the collected vehicle related data to the at least one battery 201B via the communication means in at least one of real time, at periodic intervals, or on one or more pre-defined events occurring (such as, but not limited to, an emergency fault with the EV 201, and so on). In step 402, the MCU 201A communicates the received data to the battery 201B. On receiving the data from the MCU 201A, in step 403, the battery 201B communicates the received data to the external entity, via the GPS/GPRS module 201B1. The battery 201B communicates the received data to the external entity, via the GPS/GPRS module 201B1 in at least one of real time, at periodic intervals, or on one or more pre-defined events occurring (such as, but not limited to, (such as, but not limited to, an emergency fault with the EV 201, a tampering attempt with the EV, and so on). In step 404, the cloud (which can be an example of the external entity) correlates the EV 201 and the battery 201B based on pre-stored information (which was stored at the time of dispensing the battery 201B to the EV 201). The various actions in method 400 may be performed in the order presented, in a different order or simultaneously. Further, in some embodiments, some actions listed in FIG. 4 may be omitted.

Embodiments herein enable a reduction in complexity and components in the vehicle, as the battery in an EV replaces the functionality of the VCU. This reduces the number of components in the EV, and the resultant wiring. This also results in a reduction in the costs.

The embodiments disclosed herein can be implemented through at least one software program running on at least one hardware device and performing network management functions to control the network elements. The elements include blocks which can be at least one of a hardware device, or a combination of hardware device and software module.

The embodiments disclosed herein describe an electric vehicle (EV), wherein the EV does not include a Vehicle Control Unit (VCU) module, and a Global System for Mobile Communications/General Packet Radio Service (GSM/GPRS) module, and a battery present in the vehicle can communicate data received from a Motor Control Unit (MCU) in the EV to at least one external entity using a GSM/GPRS module (which is present in the battery). Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

We claim:

1. An electric vehicle comprising:
a motor control unit configured to:
collect data from at least one of one or more modules/sensors present in the electric vehicle and from at least one motor; and
communicate the collected data to at least one battery; and
said at least one battery, configured to communicate the received data to at least one external entity,
wherein the electric vehicle does not include a vehicle control unit.

2. The electric vehicle, as claimed in claim 1, wherein the motor control unit is configured to communicate the collected data to the at least one battery in at least one of:
real time,
at periodic intervals, and
on one or more pre-defined events occurring.

3. The electric vehicle, as claimed in claim 1, wherein at least one battery is configured to communicate the received data to the at least one external entity in at least one of:
real time,
at periodic intervals, and
on one or more pre-defined events occurring.

4. The electric vehicle, as claimed in claim 1, further comprising at least one display, wherein the display is configured to:
receive the collected data from the motor control unit; and
display the received data.

5. A method for managing data in an electric vehicle, comprising:
collecting data, by a motor control unit in the electric vehicle, from at least one of one or more modules/sensors present in the electric vehicle and from at least one motor;
communicating, by the motor control unit, the collected data to at least one battery in the electric vehicle; and
communicating, by the at least one battery, the received data to at least one external entity,
wherein the electric vehicle does not include a vehicle control unit.

6. The method, as claimed in claim 5, further comprising:
communicating, by the motor control unit, the collected data to the at least one battery in at least one of:
real time,
at periodic intervals, and
on one or more pre-defined events occurring.

7. The method, as claimed in claim 5, further comprising:
communicating, by the at least one battery, the received data to the at least one external entity in at least one of:
real time,
at periodic intervals, and
on one or more pre-defined events occurring.

8. The method, as claimed in claim 5, further comprising:
communicating, by the motor control unit, the collected data to at least one display in the electric vehicle; and
displaying, by the at least one display, the received data.
